(19) United States
(12) Patent Application Publication
(10) Pub. No.: US 2008/0190701 A1
(43) Pub. Date: Aug. 14, 2008

(54) Spring powered engine

(76) Inventor: John P. Stavropoulos, Toronto (CA)

Correspondence Address: RICHES, MCKENZIE & HERBERT, LLP, SUITE 1800, 2 BLOOR STREET EAST, TORONTO, ON, M4W 3J5, omitted

(21) Appl. No.: 12/081,152

(22) Filed: Apr. 11, 2008

Related U.S. Application Data
(63) Continuation-in-part of application No. 10/954,165, filed on Oct. 1, 2004.

(51) Int. Cl. F03G 1/00

(52) U.S. Cl. 185/40 R

(57) ABSTRACT

A spring powered engine comprising a first gear having a cylindrical outer casing with gear threads positioned on a radial circumference of the outer casing. A rotatable first gear shaft is positioned through the outer casing and a spring coil is disposed within the outer casing, the spring coil having one end fixed to the first gear shaft and another end fixed to an inner circumference of the cylindrical outer casing. A motor is provided to wind the coil spring, and the uncoiling of the coil spring rotates the first gear which, through a series of gears and pulleys, rotates a transmission shaft to power a vehicle.

### RELATED APPLICATION

This application is a continuation-in-part of U.S. patent application Ser. No. 10/954,165, entitled “SPRING POWERED ENGINE”, filed Oct. 1, 2004, and which claims the benefit under 35 U.S.C.120 to U.S. patent application Ser. No. 10/954,165, filed Oct. 1, 2004.

### SCOPE OF THE INVENTION

The present invention relates to a spring powered engine, particularly to provide power to propel a vehicle.

### BACKGROUND OF THE INVENTION

Internal combustion engines are known. Internal combustion engines burn non-renewable fossil fuels to produce power to propel a vehicle. As the combustion of fossil fuel is incomplete, and because there are impurities in the fuel, the combustion produces gases and fine particulate matter as by-products. Among the gases produced by combustion are Co₂, Noₓ and Soₓ. These gases are known as greenhouse gases. Greenhouse gases and particulate matter contribute to poor air quality and other environmental problems. Another disadvantage of prior art internal combustion engines is that they produce noise pollution.

Internal combustion engines also require many component parts such as the engine block with its cylinders, pistons, valves, spark plugs, carburetor, exhaust system, cooling system, gas tank, their attachments and accessories.

### SUMMARY OF THE INVENTION

Accordingly, it is an object of this invention to at least partially overcome the disadvantages of the prior art. The present invention provides an engine powered by the uncoiling of a spring converting static energy to kinetic energy. The present invention overcomes the disadvantages of known internal combustion engines as no fossil fuels are burned during operation of the spring powered engine. As such, the present invention is less harmful to the environment and solves many of the problems associated with known fossil fuel burning engines. Also, the spring powered engine of the present invention is less noisy than internal combustion engines.

The present invention is also advantageous as it provides a more cost effective engine given the limited availability of non-renewable fuels and the continual increase in fuel prices.

Another object of the present invention is to overcome endurance problems of known engines, and to provide an engine which improves function and life expectancy.

In one aspect, the present invention provides an engine comprising: a first gear having a substantially cylindrical outer casing with gear teeth positioned on a radial circumference of the outer casing; a rotatable first gear shaft positioned through the outer casing; a spring coil having a first end and a second end, the spring coil being disposed within the outer casing, the first end being fixed to the first gear shaft and the second end being fixed to an inner circumference of the first gear casing; a motor coupled to the first gear shaft by a motor belt to rotate the first gear shaft and wind the spring coil; a second gear fixed on a second gear shaft, the second gear rotatably engaging the first gear; a third gear fixed on a third gear shaft, the third gear rotatably engaging the second gear; a first bevel gear fixed on a bevel gear shaft, the first bevel gear being connected to the third gear by a gear belt positioned between a pulley fitted on the third gear shaft and a bevel gear pulley positioned on the bevel gear shaft; and the first bevel gear engaging a transmission bevel gear attached to a transmission shaft, wherein unwinding of the spring coil rotates the first gear, which rotates the second and third gears rotating the first bevel gear to rotate the transmission bevel gear and transmission shaft to propel a vehicle.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows a perspective view of an automobile with a spring powered engine in accordance with one embodiment of the present invention;

FIG. 2 shows a perspective view of a spring powered engine in accordance with another embodiment of the present invention;

FIG. 3 shows the spring powered engine of FIG. 2 in perspective view from an opposite side;

FIG. 4 shows the spring powered engine of FIG. 2 from a top view; and

FIG. 5 shows the spring powered engine of FIG. 2 from a side view.

### DETAILED DESCRIPTION OF THE PREFERRED EMBODIMENTS

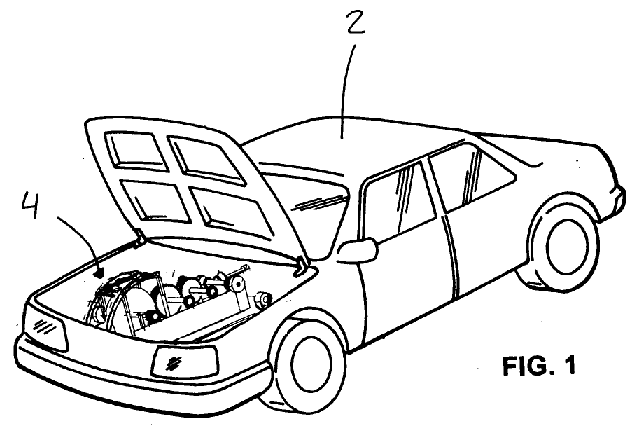

FIG. 1 shows an automobile 2 with a spring powered engine 4 of the present invention fitted within an engine compartment of the automobile 2.

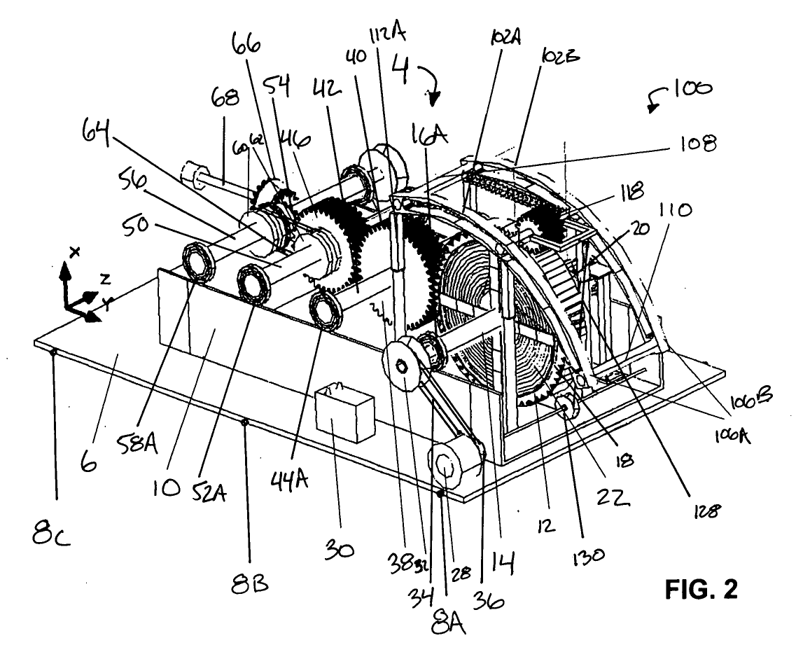

FIG. 2 shows a spring powered engine 4 in accordance with another embodiment of the present invention. The engine 4 is supported by a platform 6. Preferably, the platform 6 is a rectangular sheet of metal approximately one centimetre thick.

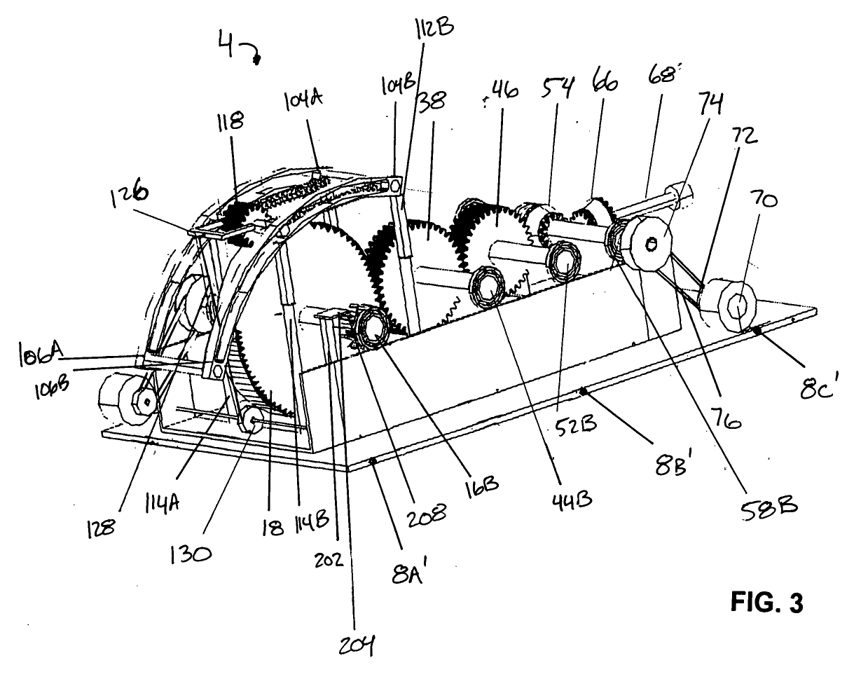

The platform 6 is sized to fit in an engine compartment of an automobile. The platform is fixed at a desired height, for example by welding or bolting to the chassis between the front wheels of any ordinary passenger automobile. As shown in FIGS. 1 and 2, the platform 6 has six bolts 8A, 8B, 8C, 8A′, 8B′, and 8C′ screwed into boreholes along longitudinal edges of the platform 6. To fix the platform within the engine compartment, the bolts 8A, 8B, 8C, 8A′, 8B′, and 8C′ are positioned through holes in the chassis and screwed into their respective boreholes. The number of bolts can vary depending on the size of the engine. FIG. 2 shows three holes 8A, 8B and 8C. FIG. 3 shows three holes 8A′, 8B′ and 8C′ on an opposite side of the platform 6.

A base 10 is fixed to the platform 6. A first gear or headgear 12 is positioned at a front end of the platform 6. The first gear 12 is rotatable about a first axle or shaft 14. The first axle 14 has bearings 16A, 16B at each end, as shown in FIGS. 2 and 3. The bearings 16A, 16B are fixed to the base 10 so that the first axle 14 is freely rotatable.

The first gear 12 is a largest of all gears. As shown in FIG. 3, the first gear 12 has a substantially cylindrical outer casing 18. A plurality of gear teeth 20 are positioned on a radial circumference of the cylindrical outer casing 18.

As shown in FIG. 2, a spring coil 22 is housed within the cylindrical outer casing 18. The spring coil 22 has a first end 24 fixed to the first axle 14, and a second end 26 fixed to an inner circumference of the cylindrical casing 18.

Preferably, the spring coil 22 is a metal strip which is six meters long, six centimeters wide and one and a half millimeters thick. The spring 22 is attached to the inner circumference of the outer casing 18 by suitable mechanical fasteners.

A motor 28 is provided to wind the spring coil 22. The motor 28 is fixed to the platform 6, as shown in FIG. 2. A battery 30 is provided to power the motor 28. Preferably, the battery 30 is a 12 volt direct current battery, and the motor 28 is a direct current motor. Although not shown, the motor 28 is connected to a power switch in a cabin of an automobile in which the spring powered engine 4 is installed. A driver of the automobile can then switch the motor on and off by the power switch.

A pulley 32 is fixed at an end of the first shaft 14. A belt 34 is fitted around the pulley 32 and a wheel 36 of the motor 28. When the motor is activated, the fly wheel 36 winds and causes the belt 34 to turn to rotate the pulley 32. The rotation of the pulley 32 causes the first shaft 14 to rotate about its longitudinal axis. The rotation of the first shaft 14 causes the spring coil 22 to wind thereby storing potential energy in the wound coil 22. When the spring coil 22 unwinds, the stored potential energy is converted to kinetic energy and the cylindrical casing 18 rotates.

A second gear 38 is positioned adjacent the first gear 12. The second gear 38 has teeth 40 positioned on an outer radial circumference, and the teeth 40 are in mesh with the first gear teeth 20. The second gear 38 is rotatable on a second gear shaft 42. The second gear shaft 42 is freely rotatable on bearings 44A and 44B. The bearings 44A and 44B are fixed to the base 10. The rotation of the first gear 12 causes the second gear 38 to rotate in an opposite direction.

A third gear 46 is positioned adjacent the second gear 38. The third gear 46 has teeth 48 positioned on an outer radial circumference, and the teeth 48 are in mesh with the second gear teeth 40. The third gear 46 rotates about a third gear shaft 50. The third gear shaft 50 is freely rotatable on bearings 52A, 52B positioned at opposite ends of the third gear shaft 50. The bearings 52A, 52B have outer casings fixed to the base 10. When the second gear 38 rotates, the third gear 46 is caused to rotate in an opposite direction, which is the same direction of rotation as the first gear 12.

A first bevel gear 54 is fixed on a bevel gear shaft 56. The bevel gear shaft 56 is freely rotatable on bearings 58A, 58B, positioned at opposite ends of the bevel gear shaft 56. The bearings 58A, 58B have outer casings fixed to the base 10.

A pulley or wheel 60 is provided on the bevel gear shaft 56. A similar pulley or wheel 62 is fixed on the third gear shaft 50. A belt 64 is fitted around each pulley 60 and 62, so that rotation of the third gear shaft 50 is transmitted to the bevel gear shaft 56 by movement of the belt.

A second or transmission bevel gear 66 is fixed to a transmission shaft 68. The second bevel gear 66 has teeth which mesh with teeth of the first bevel gear 54. Accordingly, rotation of the first bevel gear 54 causes the second bevel gear 66 to rotate. The rotation of the second bevel gear 66 rotates the transmission shaft 68 in an axis transverse to an axis of rotation of the first bevel gear shaft 56.

An alternator 70 is fixed to the platform 6. A rotatable wheel 72 is fixed to a shaft of the alternator 70. A pulley 74 is fixed to an end the first bevel gear shaft 56. A belt 76 is fitted around the rotatable wheel 72 and pulley 74 so that rotation of the first bevel gear shaft 56 causes the pulley 74 to rotate and, in turn, the rotatable wheel 72 to rotate by action of the belt. The rotation of the rotatable wheel 72 provides kinetic energy to the alternator. This kinetic energy is convereted into potential energy in the form of electricity. The alternator 70 is connected to the battery (not shown) and the electricity produced by the alternator recharges the battery.

An accelerator apparatus, generally indicated by numeral 100, is provided. The accelerator apparatus 100 comprises two accelerator slides 102A, 102B. The accelerator slides 102A, 102B are semi-circular blades elongated between a respective top end 104A, 104B, and a respective bottom end 106A, 106B.

A top connecting arm 108 is fixed between the top ends 104A, 104B of each of the accelerator slides 102A, 102B. A bottom connecting arm 110 is fixed between the bottom ends 106A, 106B of each of the accelerator slides 102A, 102B.

Upper end support posts 112A, 112B are elongated columns with upper ends fixed to the top ends 104A, 104B. Bottom ends of the upper end support posts 112A, 112B are fixed to the platform 6.

Lower end support posts 114A, 114B are elongated columns with upper ends fixed to the bottom ends 106A, 106B. Bottom ends of the lower end support posts 114A, 114B are fixed to the platform 6.

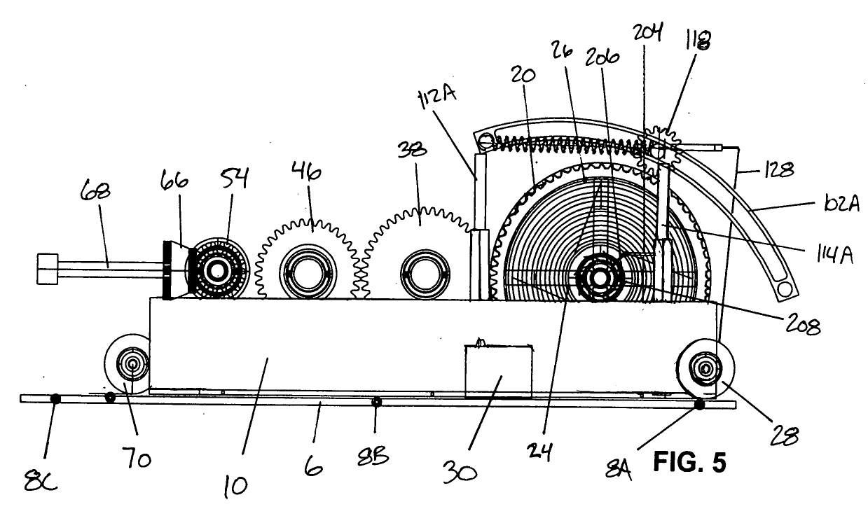

Each of the acceleration slides 102A, 102B has a respective opening 116A, 116B. FIG. 5 shows opening 116A.

In a preferred embodiment, the accelerator slides 102A, 102B are metal and are two millimeters thick. Preferably, the connecting arms 108, 110 are elongated cylindrical metallic posts which are one and a half centimeters thick. Preferably, each end of each of the connecting arms 108, 110 are threaded so that they can be screwed into respective threaded holes at ends of the acceleration slides 102A, 102B.

An acceleration gear 118 is provided with a shaft 120. The shaft 120 is fitted in the respective openings 116A, 116B of the acceleration slides 102A, 102B. The accelerator gear 118 has teeth 122 which mesh with the teeth of the first gear. The accelerator gear freely rotates with the rotation of the first gear.

Acceleration springs 124A, 124B have respective first ends fixed to the top connecting arm 108. Second ends of the acceleration springs 124A, 124B are fixed to the acceleration gear shaft 120. The acceleration springs 124A, 124B are provided to bias the acceleration gear 118 at a desired location.

An acceleration gear handle 126 is fixed to the shaft 120. An accelerator gear cord 128 has a first end fixed to the acceleration gear handle 126. A portion of the accelerator gear cord 128 passes over a pulley 130 to deflect the accelerator gear cord 128. Although not shown, a second end of the acceleration gear cord 128 is fixed to an accelerator pedal in a cabin of an automobile (not shown).

Preferably, the acceleration cord 128 is a metallic cord and is tied on the acceleration handle 126.

The accelerator pedal is pivotally coupled within the automobile cabin to apply a tensile force on the acceleration gear cord 128, for example when the accelerator pedal is depressed. This moves the accelerator gear 118 through an arcuate path in the direction of rotation of the first gear 12.

The accelerator gear 118 is configured to lock, so as to not rotate, when it is moved in a direction of rotation of the first gear 12. As the teeth of the accelerator gear 118 are meshed with the teeth of the first gear 12, the arcuate motion of the accelerator gear 118 applies a force on the first gear 12 in a direction tangent to an arc of rotation. This increases a speed of rotation of the first gear 12 to provide “acceleration”.

When the acceleration pedal is released, the acceleration gear 118 is moved back to its resting position by action of the acceleration springs 124A, 124B. Thus, by “pumping” the acceleration pedal, a user can accelerate the rotation of the first gear 12, which in turn accelerates the speed of travel of the automobile.

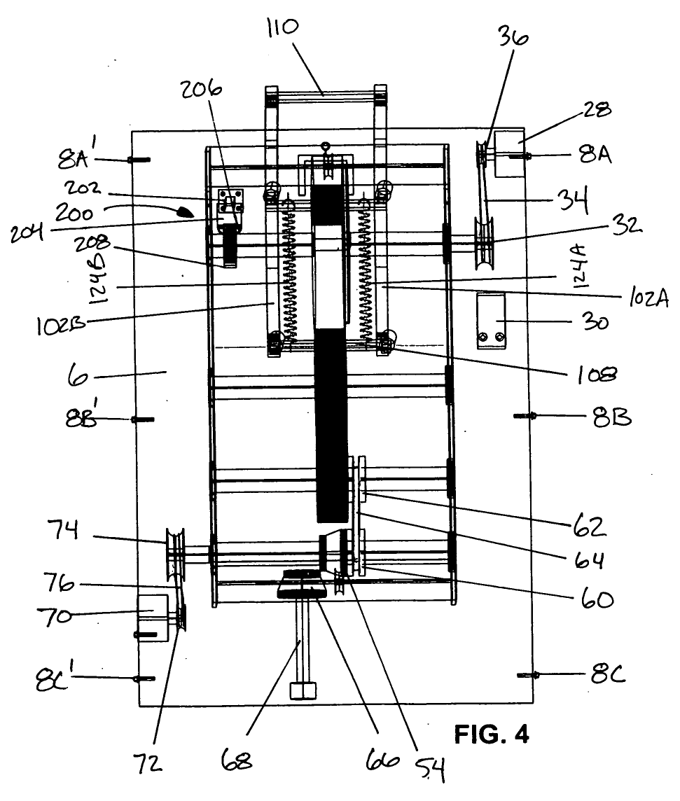

As shown in FIGS. 4 and 5, a spring holder 200 is provided to prevent the spring coil 22 from unwinding, for example, when the automobile is stopped. When the spring coil 22 is not being wound by the motor 28, the spring coil 22 will have a tendency unwind and rotate the first gear shaft 14 in a reverse direction. The spring holder apparatus 200 prevents the spring coil 22 from unwinding to conserve an amount of potential energy in the wound spring coil 22 when the motor is not winding the spring.

The spring holder 200 has a vertical post 202 fixed at a bottom end thereof to the platform 6. An arm 204 extends horizontally from a top end of the post 202. A loop 206 is attached to the arm 204 in a downward articulation such that it contacts the plurality of hooks 208.

As shown in FIG. 5, the hooks 208 are disposed around the first gear shaft 14, such that the hooks 208 engage the loop 206 if rotated in a counterclockwise direction. When this occurs, one of the hooks 208 is held by the loop 206 to prevent the spring coil 22 from unwinding. However, when rotated clockwise, the hooks 208 do not catch the loop 206.

The operation of the spring powered engine 4 is now described with reference to FIGS. 2 to 5.

When the power switch is turned on, the motor 28 winds the spring coil 22. The unwinding of the spring coil 22 rotates the outer casing 18 of the first gear 12. The rotation of the outer casing 18 effects rotational motion to the second gear 38, and consequently the third gear 46. The third gear 46 is connected to a first bevel gear 66 by the belt and pulley apparatus, to rotate the first bevel gear 54 in the same direction of rotation as the third gear 46. The first bevel gear 54 is in mesh with the second or transmission bevel gear 66 to transmit the rotation to the transmission shaft 68 to power the automobile.

Stepping on the accelerator pedal moves the acceleration gear 128 through an arcuate path in the direction of travel of the first gear 12 to cause the speed of the automobile to accelerate to a desired speed.

Stepping on the brakes stops the automobile, and the stopper apparatus 200 keeps the spring coil 22 from unwinding.

While the spring powered engine 4 is in operation, the alternator 70 provides electrical charge back to the battery 30.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein.

It will be understood that, although various features of the invention have been described with respect to one or another of the embodiments of the invention, the various features and embodiments of the invention may be combined or used in conjunction with other features and embodiments of the invention as described and illustrated herein.

1. An engine comprising:
a first gear having a substantially cylindrical outer casing with gear teeth positioned on a radial circumference of the outer casing;
a rotatable first gear shaft positioned through the outer casing;
a spring coil having a first end and a second end, the spring coil being disposed within the outer casing, the first end being fixed to the first gear shaft and the second end being fixed to an inner circumference of the first gear casing;
a motor coupled to the first gear shaft by a motor belt to rotate the first gear shaft and wind the spring coil;
a second gear fixed on a second gear shaft, the second gear rotatably engaging the first gear;
a third gear fixed on a third gear shaft, the third gear rotatably engaging the second gear;
a first bevel gear fixed on a bevel gear shaft, the first bevel gear being connected to the third gear by a gear belt positioned between a pulley fitted on the third gear shaft and a bevel gear pulley positioned on the bevel gear shaft; and
the first bevel gear engaging a transmission bevel gear attached to a transmission shaft,
wherein unwinding of the spring coil rotates the first gear, which rotates the second and third gears rotating the first bevel gear to rotate the transmission bevel gear and transmission shaft to propel a vehicle.

2. The engine of claim 1, further comprising:
an acceleration gear being fixed on an acceleration gear shaft, the acceleration gear engaging the first gear and freely rotating with a rotation of the headgear,
the acceleration gear having an acceleration handle hooked on the acceleration gear shaft such that the acceleration gear rotates the first gear when a force is applied to the acceleration handle.

3. The engine of claim 1, wherein the motor is powered by a battery, and an alternator is coupled to the first bevel gear to provide electrical charge back to the battery when the bevel gear is rotated.

4. The engine of claim 1, further comprising:
an acceleration gear being fixed on an acceleration gear shaft, the acceleration gear engaging the first gear and freely rotating with a rotation of the first gear,
the acceleration gear having an acceleration handle hooked on the acceleration gear shaft such that the acceleration gear rotates the first gear when a force is applied to the acceleration handle, and wherein
the motor is powered by a battery, and an alternator is coupled to the first bevel gear to provide electrical charge back to the battery when the bevel gear is rotated.
